(19) United States
(12) Patent Application Publication
(10) Pub. No.: US 2026/0179979 A1
(43) Pub. Date: Jun. 25, 2026

(54) FUEL CELL APPARATUS FOR SHIPS

(71) Applicants: HYUNDAI MOTOR COMPANY, SEOUL (KR); KIA CORPORATION, SEOUL (KR)

(72) Inventors: Hee Sung Yoon, Hwaseong-si (KR); Hyo Chang Choi, Hwaseong-si (KR); Kyu Hwan Oh, Hwaseong-si (KR); Yeon Sik Jeon, Hwaseong-si (KR); Sang Hoon Ahn, Hwaseong-si (KR)

(73) Assignees: HYUNDAI MOTOR COMPANY, SEOUL (KR); KIA CORPORATION, SEOUL (KR)

(21) Appl. No.: 19/228,288

(22) Filed: Jun. 4, 2025

(30) Foreign Application Priority Data
Dec. 19, 2024 (KR) 10-2024-0191457

(51) Int. Cl. H01M 8/04089; H01M 8/04029; H01M 8/04082; H01M 8/249

(52) U.S. Cl. CPC H01M 8/04089; H01M 8/04029; H01M 8/04201; H01M 8/249; H01M 2250/20

(57) ABSTRACT

Disclosed is a fuel cell apparatus for ships. The fuel cell apparatus includes a fuel cell stack, a hydrogen line forming a path to allow hydrogen to flow into the fuel cell stack therethrough or allow hydrogen discharged from the fuel cell stack to flow therethrough, a cabinet configured to accommodate the fuel cell stack and the hydrogen line and including a plurality of spaces defined therein, and a ventilation device disposed on an upper end portion of the cabinet and configured to ventilate a space accommodating the fuel cell stack and the hydrogen line among the plurality of spaces.

### CROSS REFERENCE TO RELATED APPLICATIONS

This application claims the benefit of Korean Patent Application No. 10-2024-0191457, filed on Dec. 19, 2024, which is hereby incorporated by reference as if fully set forth herein.

### BACKGROUND

### Field

Embodiments relate to a fuel cell apparatus for ships.

### Discussion of the Related Art

A fuel cell apparatus is a power generation apparatus that is capable of producing electricity through a chemical reaction of fuel using a catalyst. Such a fuel cell apparatus is utilized as a power source in various fields (e.g., transportation means such as ships).

Examples of materials used as fuel include hydrogen, hydrocarbons, and hydrocarbon compounds. Among these materials, hydrogen reacts with oxygen to generate water, thermal energy, and electrical energy.

A fuel cell apparatus may broadly include a fuel cell stack configured to generate electrical energy, a fuel tank configured to store fuel such as hydrogen, a fuel processing system (FPS) configured to supply fuel to the fuel cell stack, a hydrogen recirculation system (HRS) configured to allow hydrogen discharged from the fuel cell stack without being used in a chemical reaction to flow back into the fuel cell stack, an air processing system (APS) configured to supply oxygen in the air, which is an oxidizer necessary for an electrochemical reaction, to the fuel cell stack, a thermal management system (TMS) configured to maintain water balance across the apparatus and control the operating temperature of the fuel cell stack, and a vent system configured to discharge air, hydrogen, and water having undergone reaction from the fuel cell stack.

In particular, compared to a fuel cell apparatus for vehicles, a fuel cell apparatus for ships is required to produce high output ranging from hundreds of kW to tens of MW, to be capable of producing this high output in a limited space, and to meet strict explosion-prevention and fire-prevention requirements for ships.

Therefore, a fuel cell apparatus for ships (hereinafter, for convenience of description, interchangeably referred to as a “fuel cell apparatus”) needs to be installed such that devices capable of satisfying the above-described conditions and various components included in the fuel cell apparatus are appropriately disposed

### SUMMARY

Accordingly, embodiments are directed to a fuel cell apparatus for ships that substantially obviates one or more problems due to limitations and disadvantages of the related art.

Embodiments provide a layout of a fuel cell apparatus in which components of a fuel cell are efficiently disposed so as to produce high power in a limited space.

In addition, embodiments provide a fuel cell apparatus capable of defining a separate hazardous zone and forcibly ventilating the hazardous zone, thereby satisfying explosion-prevention and fire-prevention regulations for ships.

However, the objects to be accomplished by the embodiments are not limited to the above-mentioned objects, and other objects not mentioned herein will be clearly understood by those skilled in the art from the following description.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

A fuel cell apparatus for ships according to an embodiment of the present disclosure may include a fuel cell stack, a hydrogen line forming a path to allow hydrogen to flow into the fuel cell stack therethrough or allow hydrogen discharged from the fuel cell stack to flow therethrough, a cabinet configured to accommodate the fuel cell stack and the hydrogen line and including a plurality of spaces defined therein, and a ventilation device disposed on an upper end portion of the cabinet and configured to ventilate a space accommodating the fuel cell stack and the hydrogen line among the plurality of spaces.

In an example, the cabinet may include a partition wall separating the plurality of spaces from each other and sidewalls defining boundaries of the plurality of spaces.

In an example, the plurality of spaces may include a first space ventilated by the ventilation device and a second space separated from the first space by the partition wall and disposed parallel to the first space in a horizontal direction.

In an example, the fuel cell stack may include a plurality of stacks disposed in a vertical direction and connected in parallel to each other in the first space.

In an example, at least one of the sidewalls defining the first space may include at least one first communication portion allowing the first space to communicate with an outside space therethrough, a cover configured to cover or open the at least one first communication portion, and a sealant disposed on an edge of the cover.

In an example, the cabinet may include a first device accommodated in the first space and a second device accommodated in the second space, and the first device may include the fuel cell stack and the hydrogen line.

In an example, the hydrogen line may include a hydrogen supply unit configured to supply hydrogen to the fuel cell stack and a condensate storage tank located on the path and configured to store condensate.

In an example, each of the sidewalls defining the first space may include an upper end portion including the ventilation device and a lower end portion including a ventilation air inlet formed therein so as to allow ventilation air to be introduced thereinto to ventilate the first space.

In an example, the hydrogen line may include an exhaust line allowing exhaust air discharged from the fuel cell stack to flow therethrough, and the exhaust line may penetrate the upper end portion of each of the sidewalls defining the first space.

In an example, the ventilation device and the exhaust line may be connected to an exhaust system disposed on the top of a ship.

In an example, the second device may include a thermal management unit configured to manage heat of the fuel cell apparatus and a driving unit configured to drive the fuel cell apparatus.

In an example, the thermal management unit may include a heat exchanger including a front surface portion and a rear surface portion, and the heat exchanger may include a first pipe disposed on the front surface portion, a second pipe disposed on the rear surface portion, and a third pipe penetrating the front surface portion and the rear surface portion.

In an example, electric-component coolant may flow through the first pipe, and stack coolant may flow through the second pipe.

In an example, seawater may flow through the third pipe.

In an example, the partition wall may include a through-hole formed therein so as to allow a connection part interconnecting the first device and the second device to pass therethrough and a sealing member disposed at a boundary between the connection part and the through-hole.

In an example, the cabinet may include a front door disposed on a front surface thereof, and the fuel cell apparatus may further include a power distribution unit disposed so as to be exposed when the front door is opened.

In an example, the power distribution unit may be disposed on a front wall among the sidewalls defining the first space.

In an example, at least one of the sidewalls defining the second space may include a second communication portion allowing the second device to be exposed therethrough when the front door is opened.

It is to be understood that both the foregoing general description and the following detailed description of the present disclosure are exemplary and explanatory and are intended to provide further explanation of the disclosure as claimed.

### BRIEF DESCRIPTION OF THE FIGURES

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1A is a perspective view showing a state in which a front door of a fuel cell apparatus for ships according to an embodiment of the present disclosure is closed;

FIG. 1B is a perspective view of the fuel cell apparatus for ships according to the embodiment of the present disclosure with the front door removed therefrom;

FIG. 2 is a rear view of the fuel cell apparatus for ships according to the embodiment of the present disclosure, in which illustration of a rear wall of a cabinet is omitted;

FIG. 3 is an enlarged view of area D in FIG. 1B;

FIG. 4 is an enlarged perspective view of a rear surface of the fuel cell apparatus for ships according to the embodiment of the present disclosure;

FIG. 5 is an enlarged view of areas A, B, and C in FIG. 1A; and

FIG. 6A illustrates a perspective view of a heat exchanger according to an embodiment of the present disclosure.

FIG. 6B illustrates an exploded view of a heat exchanger according to an embodiment of the present disclosure.

### DETAILED DESCRIPTION

Hereinafter, embodiments of the present disclosure will be described in detail with reference to the accompanying drawings so that those skilled in the art can easily carry out the embodiments. The present disclosure may, however, be embodied in many different forms, and should not be construed as being limited to the embodiments set forth herein. In the drawings, parts irrelevant to description of the present disclosure will be omitted for clarity. Like reference numerals refer to like elements throughout the specification.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the term “include” or “have”, when used herein, specifies the presence of stated features, integers, steps, operations, elements, components, or combinations thereof, but does not preclude the presence or addition of one or more other features, integers, steps, operations, elements, components, or combinations thereof.

The terms “-part”, “-unit”, and “-module” used in the specification mean units for processing at least one function or operation, and can be implemented as hardware, software, or combinations of hardware and software.

Although terms including ordinal numbers, such as “first”, “second”, etc., may be used herein to describe various elements, the elements are not limited by these terms. The terms may be used only as denominative meanings to distinguish one element from another, and sequential meanings thereof are determined not by names, but by context of the corresponding description.

The term “and/or” is used to include any combination of a plurality of items that are the subject matter. For example, “A and/or B” inclusively means all three cases such as “A”, “B”, and “A and B”.

When an element is referred to as being “connected” or “coupled” to another element, the element may be directly connected or coupled to the other element. However, it should be understood that another element may be present therebetween.

Unless otherwise defined, all terms used herein, which include technical or scientific terms, have the same meanings as those generally appreciated by those skilled in the art. The terms, such as ones defined in common dictionaries, should be interpreted as having the same meanings as terms in the context of pertinent technology, and should not be interpreted as having ideal or excessively formal meanings unless clearly defined in the specification.

Hereinafter, a fuel cell according to an embodiment will be described with reference to the accompanying drawings.

The fuel cell will be described using the Cartesian coordinate system (x-axis, y-axis, z-axis) for convenience of description, but may also be described using other coordinate systems. In the Cartesian coordinate system, the x-axis, the y-axis, and the z-axis are perpendicular to each other, but the embodiments are not limited thereto. That is, the x-axis, the y-axis, and the z-axis may intersect each other obliquely.

Here, the x-axis direction may be a concept including both the +x-axis direction and the −x-axis direction, the y-axis direction may be a concept including both the +y-axis direction and the −y-axis direction, and the z-axis direction may be a concept including both the +z-axis direction and the −z-axis direction.

Prior to the detailed description of a fuel cell apparatus for ships according to an embodiment of the present disclosure, prerequisite conditions associated with the drawings will be described.

In the drawings, the x-axis direction may be a direction in which a front door 130 is located at the center of the fuel cell apparatus for ships according to an embodiment of the present disclosure. The y-axis direction may be a direction perpendicular to or intersecting the x-axis direction in a horizontal direction. The z-axis direction may be a vertical direction in the fuel cell apparatus for ships, that is, a direction from below to above.

In addition, a fuel cell stack 210, a hydrogen supply unit 221, a condensate storage tank 222, an exhaust line 223, a heat exchanger 300, and a driving unit 400 including power devices necessary to drive the fuel cell are illustrated in the drawings in a highly simplified manner. This is because it is not feasible to depict all the components mounted in the fuel cell apparatus for ships in detail as they actually appear and the arrangement positions and arrangement forms of the aforementioned components are of significance in the present disclosure. The aforementioned components are the minimum components necessary to explain the features of the present disclosure. Any other parts necessary to drive the fuel cell may be included in the aforementioned components, or even if they are not, they should not be considered to be excluded from the fuel cell apparatus according to the embodiment of the present disclosure. Further details regarding this will be described later.

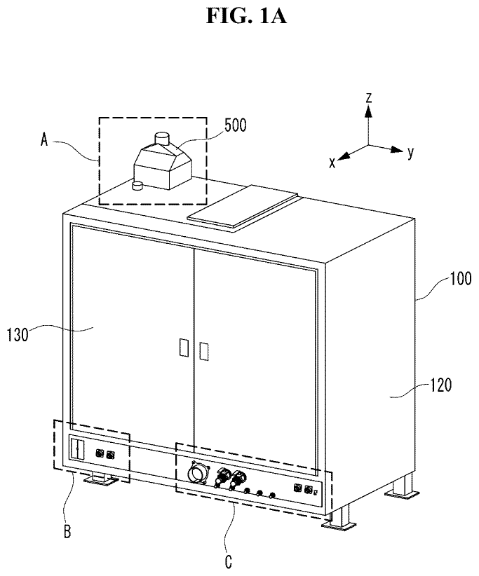

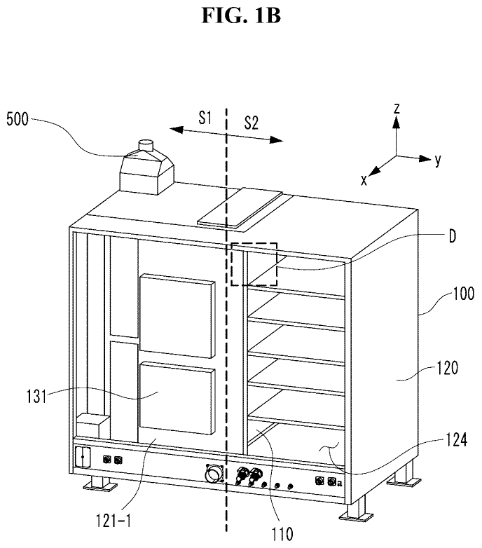

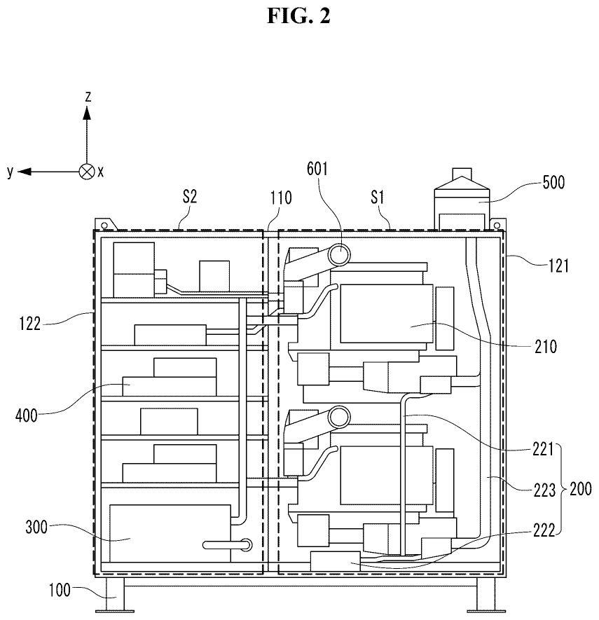

Hereinafter, the fuel cell apparatus for ships according to the embodiment of the present disclosure will be described in detail with reference to FIGS. 1 and 2. FIG. 1A is a perspective view showing a state in which the front door 130 of the fuel cell apparatus for ships according to the embodiment of the present disclosure is closed, FIG. 1B is a perspective view of the fuel cell apparatus for ships according to the embodiment of the present disclosure with the front door 130 removed therefrom, and FIG. 2 is a rear view of the fuel cell apparatus for ships according to the embodiment of the present disclosure, in which illustration of a rear wall 120 of a cabinet 100 is omitted.

The fuel cell apparatus for ships according to the present disclosure may include a fuel cell stack 210, a fuel supply unit configured to supply fuel to the fuel cell stack 210, an air supply unit configured to supply air to the fuel cell stack 210, a thermal management unit configured to manage heat and water of the fuel cell, and a driving unit 400 composed of power devices that drive and control the above components.

These components may include various devices that are not directly involved in power generation, but are necessary to drive the fuel cell, for example, peripheral parts such as an intake filter, a stack or electric-component coolant reservoir, an ion filter, and a relay box.

The fuel cell apparatus for ships according to the present disclosure may be configured such that all the components necessary to drive the fuel cell are integrated and disposed in the cabinet 100. Accordingly, the fuel cell apparatus may be more conveniently provided in a ship merely by installing the cabinet 100.

In this specification, the fuel supply unit may be interchangeably referred to as a hydrogen supply system (a concept including a hydrogen recirculation system), a hydrogen supply unit 221, or a hydrogen supply device, and the air supply unit may be interchangeably referred to as an air supply system or an air supply device including an air compressor and a humidifier. These names are merely examples and may be replaced with other names having the same or similar function and definition.

The cabinet 100 may include a ventilation device 500 mounted on the upper end portion thereof and a front door mounted to the front surface thereof. In addition, the cabinet 100 may include terminals connected to the driving unit 400 and an inlet/outlet for air or coolant required for the fuel cell apparatus, which are formed in the lower end portion of the cabinet.

The inner space in the cabinet 100 may be divided into a plurality of spaces, e.g., a first space S1 and a second space S2, by a partition wall 110. Each of the first space S1 and the second space S2 may be defined by the partition wall 110 and a sidewall 120 of the cabinet 100, and may be shielded by the front door 130.

In this case, the first space S1 may be a space that is ventilated by the ventilation device, and the second space S2 may be a space that does not require ventilation. Therefore, as shown in FIG. 1B, the first space S1 may be sealed by the partition wall 110 and the sidewall 120, unlike the second space S2. A ventilation air port, through which ventilation air flows into or out of the first space S1, may be formed in the upper or lower end portions of the sidewall 121 defining the first space S1. In addition, the ventilation device 500 may be mounted on the upper or lower end portion of the sidewall 121 defining the first space S1.

The components of the fuel cell apparatus may be divided into a first device that requires ventilation and a second device that does not require ventilation. The first device may be disposed in the first space S1, and the second device may be disposed in the second space S2. In this case, the first device requiring ventilation may include the fuel cell stack 210 and a hydrogen line 220 forming a path through which hydrogen flows into the fuel cell stack 210 or hydrogen discharged from the fuel cell stack 210 flows.

According to the Common Structure Rule (CSR) and the explosion-prevention regulation IEC 60079 presented by the International Electrotechnical Commission (IEC), a space in which the first device, in which hydrogen may flow, is mounted may be defined as a hazardous zone, and all the components provided in the hazardous zone must be implemented as explosion-prevention certified products suitable for the corresponding hazardous zone.

According to the Common Structure Rule (CSR), a space in which a stack is placed is defined as “hazardous zone 1 (ZONE 1)”. Thus, all the electronic components included in the first device must be implemented as ZONE 1 certified products. However, there is no separate explosion-prevention certification standard for a stack. Further, because the stack has all three elements of explosion, i.e., fuel, oxygen, and an ignition source, it may be difficult to completely meet explosion-prevention requirements although explosion-prevention certified components are used.

Therefore, on the basis of the explosion-prevention regulation IEC 60079-10-1, the present disclosure proposes a method of ventilating the first space S1 using a sufficient amount of air. Thereby, even when hydrogen leaks from the first device, the leaked hydrogen may be discharged outside the ship or may be diluted so as not to cause explosion. In this way, because the first space S1 is ventilated, the first device disposed in the first space S1 may not necessarily use explosion-prevention certified components.

The first device requiring ventilation may include the fuel cell stack 210 and the hydrogen line 220 forming a path through which hydrogen flows into the fuel cell stack 210 or hydrogen discharged from the fuel cell stack 210 flows. The hydrogen line 220 may include an exhaust line through which exhaust air discharged from the stack flows toward the hydrogen supply unit, the condensate storage tank 222, and the air supply unit. However, this configuration is merely exemplary, and the disclosure is not necessarily limited thereto. Any component from which hydrogen flowing thereinside may leak may be included in the first device.

On the other hand, the second device may include a component that is necessary for the fuel cell apparatus but is unlikely to be a hydrogen leakage source. For example, the second device may include a thermal management unit configured to manage heat and water of the fuel cell and a driving unit 400 composed of power devices that drive and control the thermal management unit. However, this configuration is merely exemplary, and the disclosure is not necessarily limited thereto. The second device may further include any other components that do not correspond to the first device.

As described above, in the fuel cell apparatus according to the embodiment of the present disclosure, the inner space in the cabinet 100 is divided into the first space S1, which is a ventilation area that is forcedly ventilated by the ventilation device 500, and the second space S2 in which the ventilation device 500 is not included. The first device, which is a potential hydrogen leakage source, is disposed in the first space S1, and the second device, which does not require ventilation, is disposed in the second space S2. Accordingly, the flow rate of air necessary for ventilation may be minimized, and thus the amount of energy consumed for ventilation may be reduced.

The sidewall 121 defining the first space S1 may include an upper end portion and a lower end portion. The ventilation device 500 for ventilating the first space S1 may be disposed on the upper end portion of the sidewall 121, and the ventilation air inlet may be formed in the lower end portion of the sidewall 121. The ventilation device 500 may include a device such as a ventilation fan. The ventilation device 500 may suck outside air (ventilation air) into the first space S1 through the lower end portion of the sidewall 121, and may allow the sucked ventilation air to pass through the first space S1 and to be discharged outside the fuel cell apparatus.

The upper end portion may be a concept including an upper surface located in the z-axis direction and upper ends of side surfaces located in the x-axis and y-axis directions, and the lower end portion may be a concept including a lower surface located in the z-axis direction and lower ends of the side surfaces located in the x-axis and y-axis directions. The ventilation device 500 is illustrated in the drawings as being located on the upper surface of the cabinet 100, but the disclosure is not limited thereto. The ventilation device 500 may be located on the upper end portion of the side surface located in the x-axis or y-axis direction.

The ventilation device 500 and the ventilation air inlet are illustrated in the drawings as being disposed in the upward-downward direction of the cabinet 100 so that ventilation air flows in the z-axis direction, but the ventilation direction is not necessarily limited to the z-axis direction. However, it may be desirable to set the direction in which the ventilation air is discharged from the fuel cell apparatus to the z-axis direction taking into consideration the low density of air and the practicality of forming pipes to discharge leaked hydrogen through an exhaust system of the ship (e.g., a vent mast), which is disposed on the top of the ship to finally discharge various types of gases generated in the ship to the outside of the ship.

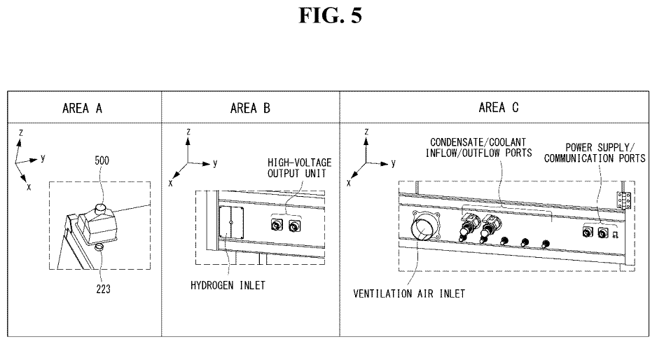

This may also be applied to the exhaust line through which exhaust air (air discharged from the fuel cell stack 210) flows so as to be finally discharged outside the ship through the exhaust system of the ship. The exhaust line 223 may be formed so as to penetrate the upper end portion of the sidewall 121 defining the first space S1, like the ventilation device 500. Therefore, the exhaust line 223 may be disposed on the upper end portion of the sidewall 121 defining the first space S1 together with the ventilation device 500 (refer to area A in FIG. 1 and area A in FIG. 5). The following description will be given on the basis of the case in which the ventilation direction is the z-axis direction.

Because the ventilation direction is the z-axis direction, the second space S2 may be disposed parallel to the first space S1 in the horizontal direction so as not to interfere with ventilation of the first space S1. Referring to FIG. 1B, the inner space in the cabinet 100 is divided into the first space S1 defined on the left and the second space S2 defined on the right with respect to the partition wall 110.

In addition, in order to optimize the ventilation flow in the first space S1, the fuel cell stack 210 may be disposed in the vertical direction in the first space S1.

Placement of the fuel cell stack 210 in the vertical direction may reduce the bottom area of the first space S1 by about a half compared to a case in which the fuel cell stack 210 is placed in the horizontal direction.

Because the air flow rate is proportional to the cross-sectional area perpendicular to the air flow direction, the small bottom area of the first space S1 may greatly reduce the flow rate of the ventilation air flowing in the z-axis direction.

In addition, when the bottom area is small, the inner space may be ventilated more uniformly than when the bottom area is large. Further, because the first space S1 is effectively ventilated only by a single ventilation device, it is not necessary to mount multiple ventilation devices and multiple discharge pipes connected thereto, thereby reducing power consumption and facilitating the design of the fuel cell apparatus.

Furthermore, in the case in which multiple fuel cell stacks 210 are connected in parallel to each other and stacked in the vertical direction, the number of stacks mounted in a given area may be increased. Therefore, the efficiency of use of the space may be improved, and high output required by the ship may be produced in a limited space.

A portion of the first space S1, other than the ventilation air inlet and the ventilation device 500 necessary for ventilation, needs to be kept airtight. Therefore, the first space S1 is completely separated from an outside space including the second space S2 by the partition wall 110 and the sidewall 120.

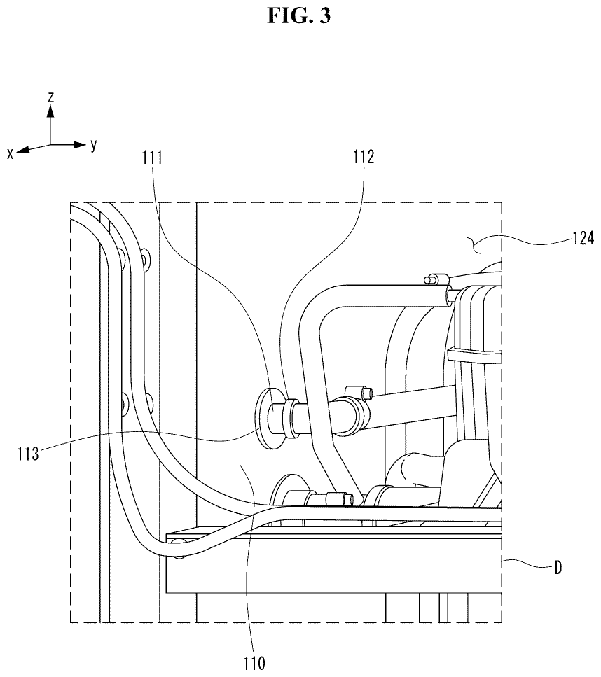

However, the first device disposed in the first space S1 and the second device disposed in the second space S2 need to be connected to each other. Therefore, referring to FIG. 3 showing area D in FIG. 1B in an enlarged manner, the partition wall 110, which separates the first space S1 and the second space S2 from each other, may include a through-hole 111 formed therein so as to allow a connection part 112 (e.g., a pipe through which coolant flows or power lines) interconnecting the first device and the second device to pass therethrough. The connection part 112 may be disposed so as to pass through the through-hole 111 formed in the partition wall 110. In this case, a boundary between the connection part 112 and the through-hole 111 may be sealed by a sealing member 113 in order to keep the first space S1 airtight.

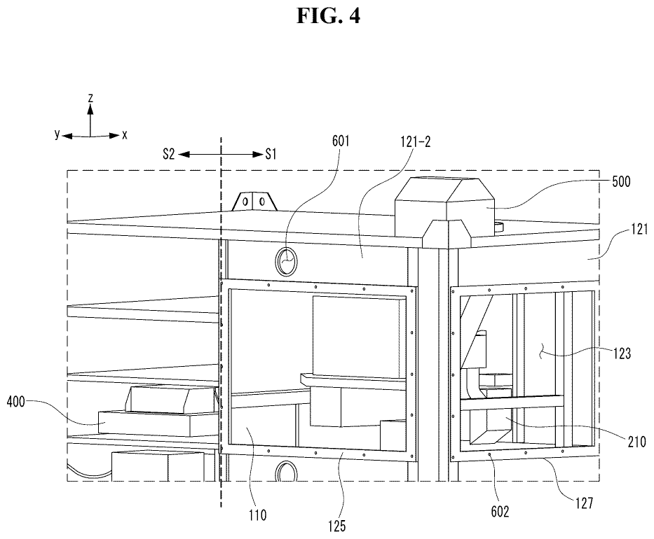

Access to the first space S1 from the outside may be required for replacement or maintenance of consumable components (e.g., an intake filter and an ion filter) included in the first device located in the first space S1. Therefore, referring to FIG. 4 illustrating an enlarged perspective view of the rear surface of the fuel cell apparatus for ships according to the embodiment of the present disclosure, in order to allow access to the first space S1 for maintenance or repair of the first device, the sidewall 121 defining the first space S1 may include at least one first communication portion 123 through which the first space S1 and the outside space communicate with each other and a cover 125 removably coupled thereto so as to cover or open the first communication portion 123.

The cover 125 may include glass in order to enable a user to check the state of the first device. The edge of the cover 125 may be secured to the sidewall 121 defining the first space S1 by means of a bolt 602, and a sealant 127 may be applied to the entire area of the edge of the cover 125 in order to secure the airtightness of the first space S1. Because the cover 125 is removably coupled to the sidewall 121 defining the first space S1, the user may remove the cover 125 from the sidewall 121 to repair or maintain the first device in the first space S1, and may couple the cover 125 to the sidewall 121 to keep the first space S1 airtight after completing repair or maintenance. A portion of the sidewall 121 defining the first space S1, other than the cover 125, and the partition wall 110 may be completely welded to each other in order to keep the first space S1 airtight.

The components included in the second device may also require replacement, repair, or maintenance, like the components included in the first device. Due to the characteristics of the ship, the fuel cell apparatus for ships is very difficult to remove once installed in the ship, and thus is highly likely to be repaired or maintained on site. Therefore, it is desirable to place the components of the fuel cell apparatus for ships so that the user is capable of easily accessing the same for repair or maintenance.

Unlike the first space S1, the second space S2 does not need to be sealed by the sidewall 122 defining the second space S2, and the sidewall 122 defining the second space S2 may include a second communication portion 124 through which the second space S2 and the outside space communicate with each other. In this case, unlike the first communication portion 123, the second communication portion 124 may not require the cover 125.

The second communication portion 124 may be disposed in the sidewall 122 defining the second space S2 so that the second device is exposed when the front door 130 of the cabinet 100 is opened. The user may easily access most areas of the second space S2 through the second communication portion 124.

In addition, in order to compensate for the characteristic of the insulation resistance being lowered when multiple fuel cell stacks 210 are connected in parallel, the fuel cell apparatus according to the present disclosure may further include an insulated fuel cell transformer (or a fuel cell DC/DC converter (FDC)), and the ventilation fan included in the ventilation device 500 may also require high voltage. In order to distribute power to the insulated FDC and the ventilation fan, the fuel cell apparatus may further include a separate power distribution unit (PDU) 131.

The power distribution unit 131 includes a relay and a fuse, which are most likely to malfunction, and thus needs to be more easily accessible. Therefore, the power distribution unit 131 may be disposed at a front portion 310-1 of the fuel cell apparatus, that is, a position that is accessible as soon as the front door is opened. In this case, the power distribution unit 131 may be disposed on a front wall 121-1 among the sidewalls 121 defining the first space S1 so as not to overlap the above-described second communication portion 124.

In the present disclosure, pipes through which various fluids (e.g. reaction air, ventilation air, condensate, and coolant) required for the fuel cell apparatus flow and power supply ports (e.g., a high-voltage or low-voltage output unit and a communication port) may be disposed as follows in consideration of convenience of design of the ship and use of the fuel cell apparatus.

As described above, the ventilation air and exhaust air in the fuel cell apparatus need to be discharged outside the ship through the exhaust system disposed on the top of the ship. Therefore, the ventilation device 500 and the exhaust line may be disposed on the upper end portion of the cabinet 100. While the ventilation device 500 is disposed on the upper end portion of the cabinet 100, the ventilation air inlet may be formed in the lower end portion of the cabinet 100.

Interfaces, such as the hydrogen inlet, the high-voltage output unit, the condensate/coolant inflow/outflow ports, the power supply port, and the communication port, may be disposed on the lower end portion of the front surface of the cabinet 100, as shown in area B and area C in FIGS. 1 and 5, in order to facilitate piping and wiring in the ship during installation of the fuel cell apparatus and thus to improve user convenience.

Air in the room in which the fuel cell apparatus is installed may be used as the reaction air. Therefore, a reaction air inlet 601 may be formed in a rear wall 121-2 among the sidewalls 121 defining the first space S1 (refer to FIG. 4). However, this configuration is merely exemplary. The reaction air inlet 601 may be located at any position, so long as the components constituting the first device are capable of being disposed in a compact manner.

In the embodiment of the present disclosure, the thermal management unit may separately manage the stack coolant for cooling the stack and the electric-component coolant for cooling the remaining electric components from each other. In order to cool both the stack coolant and the electric-component coolant, the embodiment of the present disclosure may include a heat exchanger 300. The stack coolant and the electric-component coolant may be cooled at the same time by supplying coolant used in the ship or seawater to the heat exchanger 300.

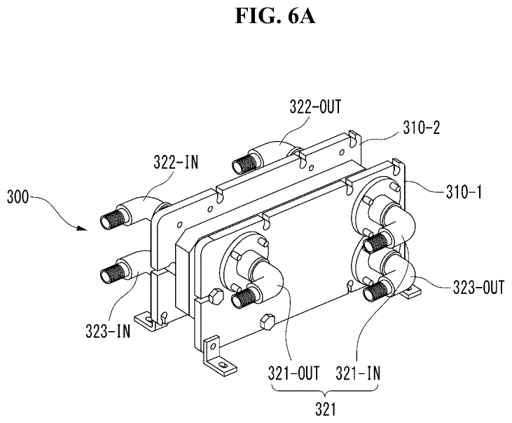

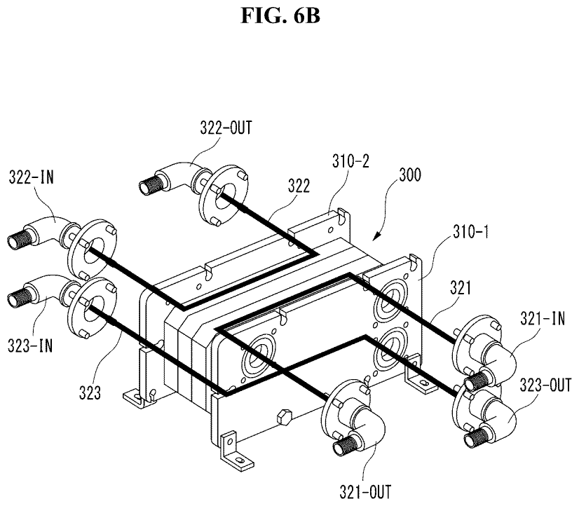

Referring to FIGS. 6A and 6B showing the heat exchanger 300 according to the embodiment of the present disclosure, the heat exchanger 300 may include a front surface portion 310-1 and a rear surface portion 310-2. A first pipe 321 through which the electric-component coolant flows may be disposed on the front surface portion 310-1, and a second pipe 322 through which the stack coolant flows may be disposed on the rear surface portion 310-2. A third pipe 323 through which seawater or the like flows may be disposed so as to penetrate both the front surface portion 310-1 and the rear surface portion 310-2 and to at least partially overlap the first pipe 321 and the second pipe 322 in the upward-downward direction, thereby cooling both the stack coolant and the electric-component coolant. However, this configuration is merely exemplary. Unlike the above configuration, it will be apparent that the stack coolant is allowed to flow through the first pipe 321 and the electric-component coolant is allowed to flow through the second pipe 322. Further, the positions of the inlet and the outlet of each of the pipes do not necessarily coincide with those shown in FIGS. 6A and 6B.

The embodiment may define the space in which the devices that are highly likely to cause fire due to hydrogen flowing therethrough are mounted as a hazardous zone, and may ventilate the hazardous zone, thereby satisfying the Common Structure Rule (CSR).

That is, according to the embodiment of the present disclosure, all the devices that are highly likely to cause fire due to hydrogen flowing therethrough may be disposed in a so-called hazardous zone, and the hazardous zone may be ventilated, so the Common Structure Rule (CSR) may be satisfied.

In addition, the bottom area of the hazardous zone may be minimized by arranging the multiple stacks in the vertical direction so as to be connected in parallel to each other. Accordingly, the amount of power produced per unit bottom area may be increased, and thus the high-output requirement may be met. Further, the amount of energy consumed for ventilation may be reduced, and the hazardous zone may be uniformly ventilated, whereby the flow rate of ventilation air may be optimized.

In addition, because consumable components in which errors frequently occur are disposed at highly accessible positions, the embodiment may provide an environment in which the user is capable of easily repairing or maintaining the consumable components in the ship. Further, because all the components necessary to drive the fuel cell are integrated and disposed in the cabinet 100, the fuel cell apparatus may be more conveniently provided in the ship merely by installing the cabinet 100.

Furthermore, the pipes through which various fluids required for the fuel cell apparatus flow and the power supply ports may be disposed at appropriate positions in consideration of convenience of design of the ship and installation of the fuel cell apparatus, and the coolants used in the fuel cell apparatus may be cooled at the same time using a single heat exchanger 300.

The present disclosure relates to a fuel cell apparatus for ships, but may also be applied to various fields in which a fuel cell apparatus is used.

As is apparent from the above description, the embodiment may define a space in which devices that are highly likely to cause fire due to hydrogen flowing therethrough are mounted as a hazardous zone, and may ventilate the hazardous zone, thereby satisfying the Common Structure Rule (CSR).

In addition, according to the embodiment, multiple stacks may be connected in parallel to each other and disposed in the vertical direction in the hazardous zone, thereby increasing the amount of power produced per unit bottom area and thus meeting the high-output requirement.

In addition, according to the embodiment, the bottom area of the hazardous zone may be minimized, thereby reducing the amount of energy consumed for ventilation and more uniformly ventilating the hazardous zone.

In addition, because consumable components in which errors frequently occur are disposed at highly accessible positions, the embodiment may provide an environment in which a user is capable of easily repairing or maintaining the consumable components in a ship.

In addition, according to the embodiment, pipes through which various fluids required for a fuel cell apparatus flow and power supply ports may be disposed at appropriate positions so that convenience of design of the ship and use of the fuel cell apparatus is improved.

In addition, according to the embodiment, because all components necessary to drive a fuel cell are integrated and disposed in a cabinet, the fuel cell apparatus may be more conveniently provided in the ship merely by installing the cabinet.

However, the effects achievable through the disclosure are not limited to the above-mentioned effects, and other effects not mentioned herein will be clearly understood by those skilled in the art from the above description.

Although only a limited number of embodiments have been described above, various other embodiments are possible. The technical contents of the above-described embodiments may be combined into various forms as long as they are not incompatible with one another, and thus may be implemented in new embodiments.

It will be apparent to those skilled in the art that various changes in form and details may be made without departing from the spirit and essential characteristics of the disclosure set forth herein. Accordingly, the above detailed description is not intended to be construed to limit the disclosure in all aspects and to be considered by way of example. The scope of the disclosure should be determined by reasonable interpretation of the appended claims and all equivalent modifications made without departing from the disclosure should be included in the following claims.

1. A fuel cell apparatus for ships, comprising:
a fuel cell stack;
a hydrogen line forming a path to allow hydrogen to flow into and through the fuel cell stack or allow hydrogen discharged from the fuel cell stack to flow therethrough;
a cabinet configured to accommodate the fuel cell stack and the hydrogen line, the cabinet including a plurality of spaces defined therein; and
a ventilation device disposed on an upper end portion of the cabinet, the ventilation device being configured to ventilate a space accommodating the fuel cell stack and the hydrogen line among the plurality of spaces.

2. The fuel cell apparatus for ships according to claim 1, wherein the cabinet includes:
a partition wall separating the plurality of spaces from each other; and
sidewalls defining boundaries of the plurality of spaces.

3. The fuel cell apparatus for ships according to claim 2, wherein the plurality of spaces includes:
a first space ventilated by the ventilation device; and
a second space separated from the first space by the partition wall and disposed parallel to the first space in a horizontal direction.

4. The fuel cell apparatus for ships according to claim 3, wherein the fuel cell stack includes a plurality of stacks disposed in a vertical direction and connected in parallel to each other in the first space.

5. The fuel cell apparatus for ships according to claim 3, wherein at least one of the sidewalls defining the first space includes:
at least one first communication portion allowing the first space to communicate with an outside space therethrough;
a cover configured to cover or open the at least one first communication portion; and
a sealant disposed on an edge of the cover.

6. The fuel cell apparatus for ships according to claim 3, wherein the cabinet includes a first device accommodated in the first space and a second device accommodated in the second space, and
wherein the first device includes the fuel cell stack and the hydrogen line.

7. The fuel cell apparatus for ships according to claim 6, wherein the hydrogen line includes:
a hydrogen supply unit configured to supply hydrogen to the fuel cell stack; and
a condensate storage tank located on the path, the condensate storage tank being configured to store condensate.

8. The fuel cell apparatus for ships according to claim 6, wherein each of the sidewalls defining the first space includes:
an upper end portion including the ventilation device; and
a lower end portion including a ventilation air inlet formed therein so as to allow ventilation air to be introduced thereinto to ventilate the first space.

9. The fuel cell apparatus for ships according to claim 8, wherein the hydrogen line includes an exhaust line allowing exhaust air discharged from the fuel cell stack to flow therethrough, and
wherein the exhaust line penetrates the upper end portion of each of the sidewalls defining the first space.

10. The fuel cell apparatus for ships according to claim 9, wherein the ventilation device and the exhaust line are connected to an exhaust system disposed on a top of a ship.

11. The fuel cell apparatus for ships according to claim 6, wherein the second device includes:
a thermal management unit configured to manage heat of the fuel cell apparatus; and
a driving unit configured to drive the fuel cell apparatus.

12. The fuel cell apparatus for ships according to claim 11, wherein the thermal management unit includes a heat exchanger including a front surface portion and a rear surface portion, and
wherein the heat exchanger includes:
a first pipe disposed on the front surface portion;
a second pipe disposed on the rear surface portion; and
a third pipe penetrating the front surface portion and the rear surface portion.

13. The fuel cell apparatus for ships according to claim 12, wherein electric-component coolant flows through the first pipe, and
wherein stack coolant flows through the second pipe.

14. The fuel cell apparatus for ships according to claim 12, wherein seawater flows through the third pipe.

15. The fuel cell apparatus for ships according to claim 6, wherein the partition wall includes:
a through-hole formed therein so as to allow a connection part interconnecting the first device and the second device to pass therethrough; and
a sealing member disposed at a boundary between the connection part and the through-hole.

16. The fuel cell apparatus for ships according to claim 6, wherein the cabinet includes a front door disposed on a front surface thereof, and
wherein the fuel cell apparatus further includes a power distribution unit disposed so as to be exposed when the front door is opened.

17. The fuel cell apparatus for ships according to claim 16, wherein the power distribution unit is disposed on a front wall among the sidewalls defining the first space.

18. The fuel cell apparatus for ships according to claim 16, wherein at least one of the sidewalls defining the second space includes a second communication portion allowing the second device to be exposed therethrough when the front door is opened.

19. A fuel cell apparatus for ships, comprising:
a cabinet including a plurality of spaces separated by a partition wall;
a ventilation device disposed on an upper portion of the cabinet;
a fuel cell stack;
a hydrogen line forming a path to allow hydrogen to flow into and through the fuel cell stack or allow hydrogen discharged from the fuel cell stack to flow therethrough;
a power distribution unit which distributes power to the devices included in the fuel cell apparatus, and
wherein the plurality of spaces comprises:
a first space having a front door of the cabinet as one wall surface; and
a second space disposed behind the first space, and
wherein the power distribution unit is disposed in the first space,
wherein the fuel cell stack and the hydrogen line are disposed in the second space, and
wherein the ventilation device is disposed on an upper portion of the cabinet forming the second space.

20. A method comprising:
forming a path via a hydrogen line to allow hydrogen to flow into and through a fuel cell stack or allow hydrogen discharged from a fuel cell stack to flow therethrough;
accommodating, via a cabinet, the fuel cell stack and the hydrogen line, the cabinet including a plurality of spaces defined therein; and
ventilating a space accommodating the fuel cell stack and the hydrogen line among the plurality of spaces.
